(19) United States
(12) Patent Application Publication
(10) Pub. No.: US 2015/0049052 A1
(43) Pub. Date: Feb. 19, 2015

(54) Wireless Device With Touch-Based Stylus

(71) Applicant: Broadcom Corporation, Irvine, CA (US)

(72) Inventors: Ian Andrew ATKINSON, Hayward, CA (US); Sumant RANGANATHAN, Saratoga, CA (US); Simon ASSOUAD, Irvine, CA (US); Eric B. RODAL, Garnerville, NV (US); Scott MCGREGOR, Irvine, CA (US)

(73) Assignee: BROADCOM CORPORATION, Irvine, CA (US)

(21) Appl. No.: 14/448,510

(22) Filed: Jul. 31, 2014

Related U.S. Application Data
(60) Provisional application No. 61/860,824, filed on Jul. 31, 2013.
(60) Provisional application No. 61/951,716, filed on Mar. 12, 2014.

(51) Int. Cl. G06F 3/0354; G06F 3/044

(52) U.S. Cl. CPC G06F 3/03545; G06F 3/044
USPC 345/174; 345/179

(57) ABSTRACT

Often times, a touch-sensitive area of a touch-screen of a communication device is touched by a finger or a hand of a user. In some instances, a touch-based stylus of the present disclosure is available to the user. The user touches the touch-sensitive area of the communication device with the touch-based stylus. The communication device induces a current within the touch-based stylus. This induced current causes a voltage to accumulate within the passive object when touched by the user. This accumulated voltage transfers to the touch-sensitive area when the touch-based stylus touches the touch-sensitive area of the communication device. Thereafter, the communication device compares signal metrics of various regions of the touch-sensitive area to detect an instance and/or a location of the touch from the touch-based stylus.

### CROSS-REFERENCE TO RELATED APPLICATIONS

The present application claims the benefit of U.S. Provisional Patent Appl. No. 61/860,824, filed Jul. 31, 2013, and U.S. Provisional Patent Appl. No. 61/951,716, filed Mar. 12, 2014, each of which is incorporated herein by reference in its entirety.

### BACKGROUND

1. Field of Disclosure

The present disclosure generally relates to operating a communication device, and including using a touch-based stylus to interface with the communication device.

2. Related Art

Conventional touch-screens are used to interact with various conventional communication devices, such as all-in-one computers, tablet computers, smartphones, personal digital assistants (PDAs), satellite navigation devices, video gaming devices, kiosk systems in retail and tourist settings, point of sale systems, or automatic teller machines (ATMs). A variety of conventional touch-screen technologies that have varying methods for sensing touch are available for use within these conventional communication devices.

One variety of conventional touch-screen technology is a capacitive touch-screen, such as a surface capacitance touch-screen, a projected capacitance touch-screen, a mutual capacitance touch-screen, or a self-capacitance touch-screen. Each of these capacitive touch-screens includes rows and columns of transparent conductive material, such as indium tin oxide to provide an example, that are arranged to form a touch-sensitive area above a display area. During operation, small electrical signals are applied to the rows and/or the columns to form local electrostatic fields. Certain local electrostatic fields between the rows and the columns can be disrupted by touching to the touch-sensitive area. Herein, a touch can represent a physical touching of the touch-sensitive area by a user of the conventional communication device and/or by a passive object available to the user, or proximity of the user and/or the passive object to the touch-sensitive area. The conventional communication device measures changes of the local electrostatic fields, in terms of changes in capacitance, to interpret an instance and/or a location of the touch.

The touch-sensitive area of the conventional touch-screen is touched by a finger or a hand of the user. However, a passive object, such as a conventional stylus to provide an example, can be available to the user. The conventional stylus represents a small tool, typically in the form of a narrow elongated staff, similar to a modern ball point pen, which is used to assist in navigating or for providing more precision when compared to the touch of the user.

### BRIEF DESCRIPTION OF THE DRAWINGS/FIGURES

FIG. 1 illustrates an exemplary communication device and a touch-based stylus according to an exemplary embodiment of the present disclosure;

FIG. 2 illustrates an exemplary configuration and arrangement of the communication device and touch-based stylus that can be implemented within the exemplary operating environment according to an exemplary embodiment of the present disclosure;

FIG. 3 illustrates a block diagram of an exemplary communication device according to an exemplary embodiment of the present disclosure;

FIG. 4 illustrates a block diagram of an exemplary communication module according to an exemplary embodiment of the present disclosure;

FIG. 5 illustrates a block diagram of a near field communication (NFC) module that can be implemented as part of the communication module core according to an exemplary embodiment of the disclosure;

FIG. 6 illustrates a simplified block diagram of an exemplary touch-based stylus that can be implemented within the exemplary operating environment according to an exemplary embodiment of the present disclosure;

FIG. 6 illustrates a more extensive block diagram of the exemplary touch-based stylus according to an exemplary embodiment of the present disclosure;

FIG. 7 illustrates a block diagram of an exemplary operation of the touch-based stylus; and

FIG. 8 illustrates a block diagram of an exemplary operation of the touch-based stylus.

The present disclosure will now be described with reference to the accompanying figures. In the drawings, like reference numbers generally indicate identical, functionally similar, and/or structurally similar elements. The figure in which an element first appears is indicated by the leftmost digit(s) in the reference number.

### DETAILED DESCRIPTION OF THE DISCLOSURE

### Overview

A user of a communication device can operate and/or control a communication device by touching a touch-sensitive area of a touch-screen of the communication device with a touch-based stylus. When the touch-based stylus is sufficiently proximate to the touch-sensitive area, the communication device begins to induce a current within the touch-based stylus. The induced current causes a voltage to accumulate within the touch-based stylus. The accumulated voltage transfers to the touch-sensitive area when the touch-based stylus touches the touch-sensitive area Thereafter, the communication device detects the touch from the touch-based stylus onto the touch-sensitive area based upon the transferred voltage. Optionally, the communication device can interpret the touch as being one or more commands and/or data from the user for operating and/or controlling the communication device.

### An Exemplary Communication Device and an Exemplary Touch-Based Stylus

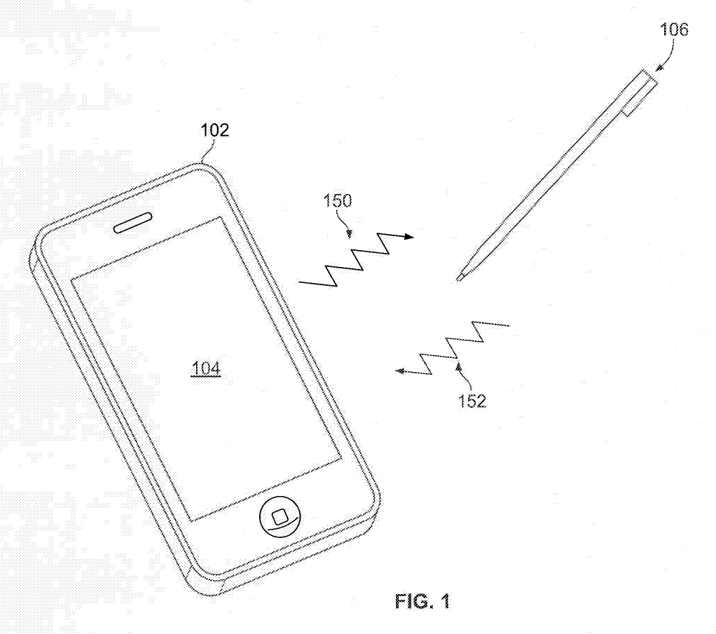

FIG. 1 illustrates an exemplary communication device and an exemplary touch-based stylus. A user of a communication device 102 can operate and/or control the communication device 102 by touching a touch-sensitive area of a touch-screen 104 of the communication device with a touch-based stylus 106. The communication device 102 communicates information, such as voice and/or data to provide some examples, over wired and/or wireless communication networks in accordance with various communication standards. Those skilled in the relevant art(s) will recognize that the present disclosure as described herein is applicable to any other suitable communication device that includes a touch-screen such as an all-in-one computer, a tablet computer, a smartphone, a personal digital assistant (PDA), a satellite navigation device, video gaming device, a kiosk system in retail and tourist settings, a point of sale system, an automatic teller machine (ATM), or any other suitable communication device that will be apparent to those skilled in the relevant art(s) without departing from the spirit and scope of the present disclosure.

As illustrated in FIG. 1, the communication device 102 includes a touch-screen 104 to provide a graphical user interface for the user. The touch-screen 104 can be implemented as a capacitive touch-screen, such as a surface capacitance touch-screen, a projected capacitance touch-screen, a mutual capacitance touch-screen, or a self-capacitance touch-screen. However, the touch-screen 104 can be implemented using other types of touch-screen technologies that will be apparent to those skilled in the relevant art(s) without departing from the spirit and scope of the present disclosure. The touch-screen 104 includes various configurations and arrangements of conductive material that form a touch-sensitive area above a display area. For example, the touch-screen 104 can include one or more rows and/or one or more columns of transparent conductive material, such as indium tin oxide to provide an example, which are configured and arranged in a grid pattern to form the touch-sensitive area above the display area. Other configurations and arrangements can be used to form the touch-sensitive area without departing from the spirit and scope of the present disclosure.

The user can touch the touch-screen 104 using a finger or other portion of their hand to interact with the communication device 102. In some instances, however, the touch-based stylus 106 is available to the user. The touch-based stylus 106 represents a small tool, typically in the form of a narrow elongated staff, similar to a ball point pen, which assists the user in interacting with the communication device 102. As additionally illustrated in FIG. 1, the communication device 102 provides an excitation signal 150 to magnetically induce a current within the touch-based stylus 106. The excitation signal 150 can be characterized as a magnetic field that is concentrated at one or more frequencies and/or that varies over one or more frequencies. When the touch-based stylus 106 is sufficiently proximate to the touch-screen 104, the excitation signal 150 magnetically induces a current within the touch-based stylus 106.

The induced current causes one or more resonant circuits within the touch-based stylus 106 to resonate at their respective resonant frequencies. The one or more resonant circuits can include one or more resistive elements, one or more capacitive elements, and/or one or more inductive elements that are configured and arranged to form a series resonant circuit, a parallel resonant circuit, or any combination thereof. In an exemplary embodiment, the respective resonant frequencies of the one or more resonant circuits are collectively selected such that a resonant frequency of the touch-based stylus 106, as whole, is approximately equal to a frequency of the excitation signal 150. The resonating of the one or more resonant circuits of the touch-based stylus 106 causes a voltage to accumulate in the touch-based stylus 106. In another exemplary embodiment, the touch-based stylus 106 is located at a sufficient distance, such as approximately two centimeters to provide an example, from the one or more resonant circuits to reduce unintentional transfer of the accumulated voltage from the touch-based stylus 106 to the touch-screen 104.

When the touch-based stylus 106 touches the touch-screen 104, the voltage capacitively transfers, as an interface signal 152, from the touch-based stylus 106 to the touch-screen 104. Typically. the interface signal 152 is characterized as having a frequency that corresponds to the respective resonant frequencies of the one or more resonant circuits of the touch-based stylus 106.

The communication device 102 detects the touch from the touch-based stylus 106 onto the touch-screen 104 based upon the interface signal 152. For example, the communication device 102 can detect an instance and/or a location of the touch from the touch-based stylus 106. In an exemplary embodiment, the communication device 102 can determine one or more signal metrics of the interface signal 152 at one or more locations within the touch-screen 104. The one or more signal metrics may include a mean voltage and/or current level, an average voltage and/or current level, an instantaneous voltage and/or current level, a root mean square voltage and/or current level, a mean power, an average power, an instantaneous power, a root mean square power, a frequency, a phase and/or any other suitable signal metric of the interface signal 152 at the one or more locations within the touch-screen 104. Thereafter, the communication device 102 can determine the instance and/or the location of the touch from the touch-based stylus 106 from the one or signal metrics. Optionally, the communication device 102 can interpret the instance and/or the location of the touch as being one or more commands and/or data from the user for operating and/or controlling the communication device 102.

### Activation of the Exemplary Communication Device to Provide the Excitation

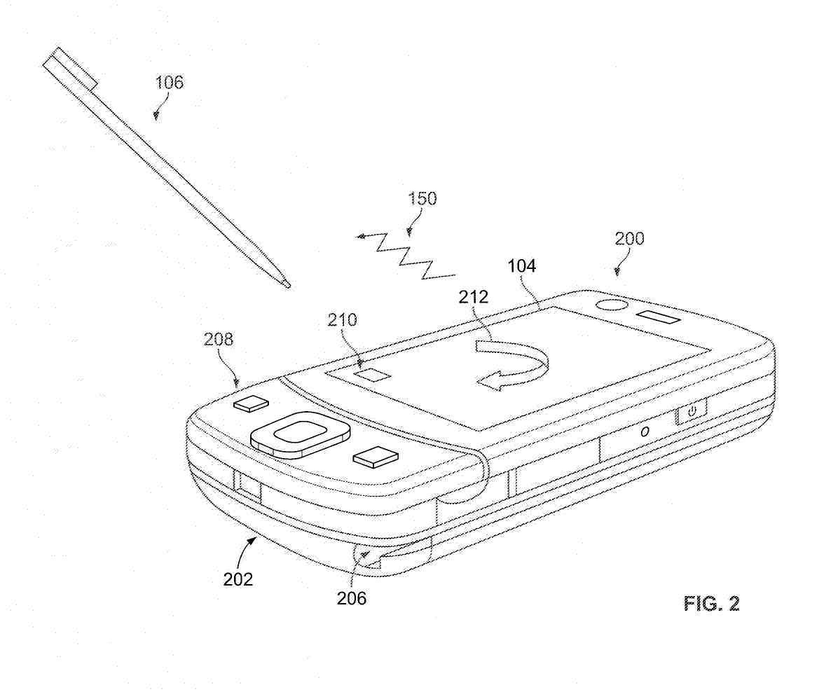

As discussed above in FIG. 1, the communication device 102 provides the excitation signal 150 to magnetically induce the current within the touch-based stylus 106. The communication device 102 can provide the excitation signal 150 at one or more instances in time, for example, a periodically, periodically, or continuously, Alternatively, or in addition to, the communication device 102 can be activated to provide the excitation signal 150 in response to one or more operations of the user. For example, FIG. 2 illustrates an exemplary communication device 200 that can be activated to provide the excitation signal 150 in response to one or more operations of the user. A user of the communication device 200 can perform one or more exemplary operations to indicate that the communication device 200 is to interface with the touch-based stylus 106. The exemplary operations can include removing the touch-based stylus 106 from the communication device 200, activating one or more buttons or switches within the communication device 200, making a predetermined motion or gesture onto a touch-screen of the communication device 200, and/or bringing the touch-based stylus 106 sufficiently proximate to the communication device 200. It should be noted that the communication device 200 need not be capable of supporting all of these exemplary operations. The communication device 200 can be activated to provide the excitation signal 150 when one or more of these exemplary operations are performed by the user. The communication device 200 can represent an exemplary embodiment of the communication device 102.

As illustrated in FIG. 2, the communication device 200 includes the touch-screen 104 and a mechanical chassis 202. The mechanical chassis 202 can include a cavity 206, such as a pressure sensitive cavity to provide an example, to store the touch-based stylus 106. The communication device 200 can provide the excitation signal 150 when the user removes, either partially or completely, the touch-based stylus 106 from the cavity 206. Additionally, the mechanical chassis 202 and/or the touch-screen 104 can include a physical button or switch 208 and a logical button or switch 210, respectively. The communication device 200 can provide the excitation signal 150 when the user activates the physical button or switch 208 and/or the logical button or switch 210. Also, the user of the communication device 200 can touch the touch-screen 104 with a predetermined motion or gesture 212. The communication device 200 can provide the excitation signal 150 when the user motions the predetermined motion or gesture 212 onto the touch-screen 104. Further, the user can bring the touch-based stylus 106 within sufficient proximity of the touch-screen 104. In an exemplary embodiment, the touch-based stylus 106 operates in a substantially similar manner as a conventional passive stylus when the one or more resonant circuits are not resonating. The communication device 200 can provide the excitation signal 150 when the touch-based stylus 106 is within sufficient proximity of the communication device 200 to disrupt local electrostatic fields within the touch-screen 104.

### Exemplary Generation of the Excitation Signal Within the Communication Device

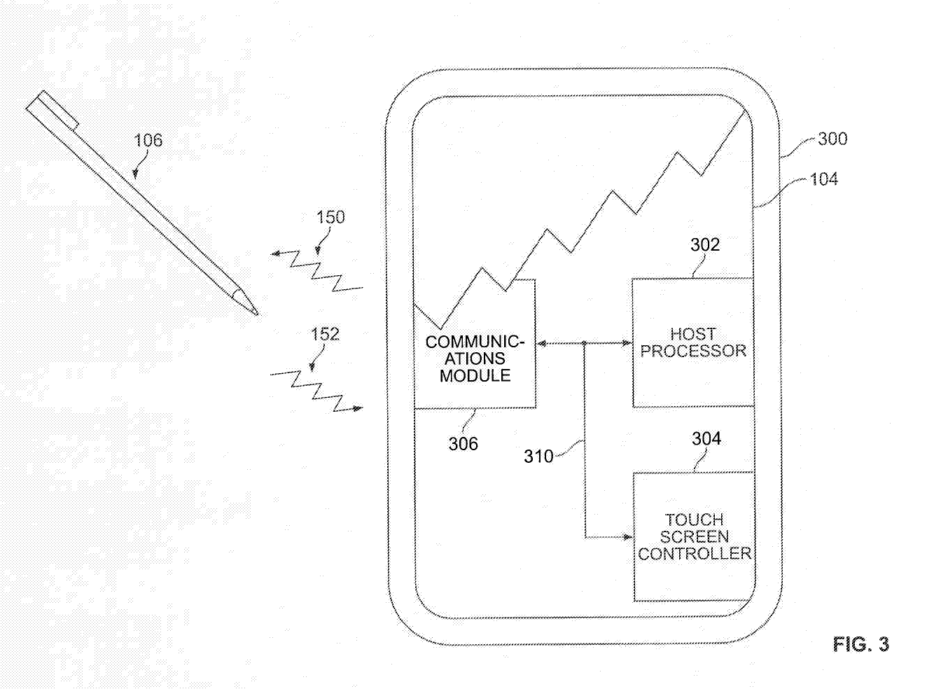

As discussed above in FIG. 1, the communication device 102 provides the excitation signal 150 to magnetically induce the current within the touch-based stylus 106. FIG. 3 further illustrates the exemplary communication device. As illustrated in FIG. 3, a communication device 300 can include a host processor 302, a touch-screen controller 304, and a communication module 306 that are communicatively coupled via a communications interface 310. References in the disclosure to a “module” shall be understood to include at least one of software, firmware, and hardware (such as one or more circuits, microchips, or devices, or any combination thereof), and any combination thereof In addition, it will be understood that each module can include one, or more than one. component within an actual device, and each component that forms a part of the described module can function either cooperatively or independently of any other component forming a part of the module. Conversely, multiple modules described herein can represent a single component within an actual device. Further, components within a module can be in a single device or distributed among multiple devices in a wired or wireless mariner.

The communication interface 310 routes various communications between the communications module 302, the host processor 304, and the touch-screen controller 304. The communication interface 310 can be implemented as a series of wired and/or wireless interconnections between the communications module 302, the host processor 304, and the touch-screen controller 304. The interconnections of the communication interface 310 can be arranged to form a parallel interface to route communications between the communications module 302, the host processor 304, and the touch-screen controller 304 in parallel, or a serial interface to route communications between the communications module 302, the host processor 304, and the touch-screen controller 304, or any combination thereof. The communication device 300 can represent an exemplary embodiment of the communication device 102.

The host processor 302 controls overall operation and/or configuration of the communication device 300. The host processor 302 can receive and/or process information from a user interface such as an alphanumeric keypad, a microphone, a mouse, a speaker, and/or from other electrical devices or host devices that are coupled to the communication device 300. The host processor 302 can provide this information to the communication module 306 and/or the touch-screen controller 304. Additionally, the host processor 302 can receive and/or process information from the communication module 306 and/or the touch-screen controller 304. The host processor 302 can provide this information to the user interface, to other electrical devices or host devices, and/or to the communication module 306 and/or the touch-screen controller 304. Further, the host processor 302 can execute one or more applications such as Short Message Service (SMS) for text messaging, electronic mailing, and/or audio and/or video recording to provide some examples, and/or software applications such as a calendar and/or a phone book to provide some examples.

The touch-screen controller 304 communicates information between the touch-screen 104, the host processor 302, and the communication module 306. The touch-screen controller 304 provides various signals to the touch-screen 104 to configure its display area to display the information. For example, the touch-screen controller 304 can provide various control signals to the touch-screen 104 to display image data or video data received from the host processor 302 and/or the communication module 306. Additionally, the touch-screen controller 304 can receive various signals from the touch-screen 104 which can be used to detect the touch from the touch-based stylus 106 as to be discussed below.

The communication module 306 can include one or more of: a Bluetooth module, a Global Position System (GPS) module, a cellular module, a wireless local area network (WLAN) module, a near field communication (NFC) module, a radio frequency identification (RFID) module and/or a wireless power transfer (WPT) module. The Bluetooth module, the cellular module, the WLAN module, the NFC module, and the RFID module provide wireless communication between the communication device 300 and other Bluetooth, other cellular, other WLAN, other NFC, and other RFID capable communication devices, respectively, in accordance with various communication standards or protocols. These various communication standards or protocols can include various cellular communication standards such as a third Generation Partnership Project (3GPP) Long Term Evolution (LTE) communications standard, a fourth generation (4G) mobile communications standard, or a third generation (3G) mobile communications standard, various networking protocols such a Wi-Fi communications standard, various NFC/RFID communications protocols such as ISO 1422, ISO/IEC 14443, ISO/IEC 15693, ISO/IEC 18000, or FeliCa to provide some examples. The GPS module receives various signals from various satellites to determine location information for the communication device 300. The WPT module supports wireless transmission of power between the communication device 300 and another WPT capable communication device.

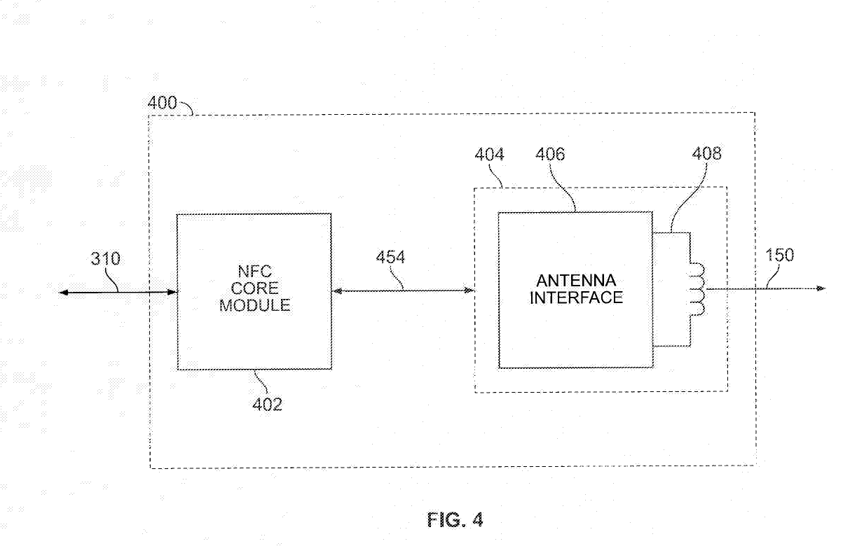

FIG. 4 illustrates a block diagram of a NFC module that can be implemented as part of the communication module 306. An NFC module 400 provides functional aspects for NFC between the NFC module 400 and another NFC capable communication device and functional aspects for providing the excitation signal 150 to the touch-based stylus 106. The NFC module 400 includes a NFC core module 402 and an antenna module 404. The NFC module 400 can represent an exemplary embodiment of the communication module 306.

The NEC core module 402 operates as an interface between the antenna module 404 and other modules of the communication device 300, such as the host processor 302 and/or the touch-screen controller 304 to provide some examples. The NEC core module 402 can include a modulator module to modulate various signals to be provided to the antenna module 404, a demodulator module to demodulate various signals provided by the antenna module 404, and/or a controller module to configure the modulator module and/or the demodulator module. As illustrated in FIG. 4, the NFC core module 402 communicates information between the other modules of the communication device 300 and the NFC module 400 via the communication interface 310. The information can include one or more commands to configure the NFC module 400 to provide the excitation signal 150 or to provide NFC between the NFC module 400 and the other NFC capable communication device. The providing of NFC between the NFC module 400 and the other NFC capable communication device is known to those skilled in the relevant art(s) and is not described in further detail.

The antenna module 404 applies a carrier wave from the NFC core module 402 to an inductive coupling element 408, such as a tuned resonant circuit to provide an example, to generate a magnetic field to provide the excitation signal 150. The antenna module 404 can also include an antenna interface 406 which represents a matching network between the NFC core module 402 and the inductive coupling element 408. In an exemplary embodiment, the antenna interface 406 and the inductive coupling element 408 form a tuned resonant circuit.

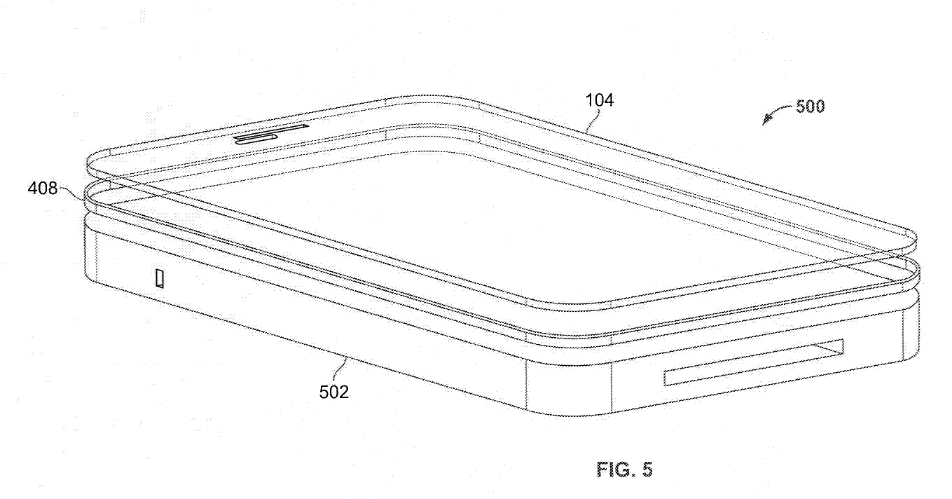

FIG. 5 illustrates an exemplary configuration and arrangement of an inductive coupling element within the exemplary communication device. As illustrated in FIG. 5, the inductive coupling element 408 can be configured and arranged within the communication device 500 to enclose all, or a substantial portion of, the touch-screen 104 with a magnetic field. The communication device 500 can represent an exemplary embodiment of the communication device 102.

In exemplary embodiments, the inductive coupling element 408 can be implemented using unshielded cable formed of a conductive material, such as copper to provide an example, that is configured and arranged to form one or more turns. These one or more turns can be enclosed within a perimeter of a mechanical chassis 502 so as to enclose all, or a substantial portion of, the touch-screen 104 with the magnetic field. The one or more turns can be configured and arranged to form any regular geometric structure, irregular geometric structure, open structure, closed structure, or any combination thereof within or on the mechanical chassis 502, such as around the perimeter of the mechanical chassis 502. However, other configurations and arrangements for the inductive coupling element 408 are possible without departing from the spirit and scope of the present disclosure. For example, the inductive coupling element 408 can be implemented as one or more turns of conductive material integrated within the mechanical chassis 502. As another example, the inductive coupling element 408 can be implemented within an interior perimeter of the communication device 500 using a waveguide, such as stripline or microstrip to provide some examples. As a further example, the inductive coupling element 408 can be implemented within the touch-screen 104.

### Exemplary Detection of the Touch from the Exemplary Touch-Based Stylus

Referring back to FIG. 3, the touch-screen controller 304 can determine the one or more signal metrics of the interface signal 152 that has capacitively been transferred to the touch-screen 104. The touch-screen controller 304 can compare the one or more signal metrics to determine a location of the touch from the touch-based stylus 106. Alternatively, the communication device 300 can compare the one or more signal metrics to one or more signal metric thresholds to determine a location of the touch from the touch-based stylus 106. Optionally, the touch-screen controller 304 can use the one or more signal metrics to determine an action of the user. For example, in some instances, the touch-based stylus 106 can include one or more physical buttons. In this example, when at least one of the one or more physical buttons is activated, a frequency and/or a phase of the interface signal 152 that is transferred onto the touch-sensitive area changes. This change in frequency and/or phase can be detected and interpreted by the touch-screen controller 304 to indicate activation of the one or more buttons by the user. In some instances, the touch-screen controller 304 and the host processor 304 can be implemented using a single processor that performs the various functions of the touch-screen controller 304 and the host processor 304. Further, the touch-screen controller 304 can interpret the location of the touch from the touch-based stylus 106 as being one or more commands and/or data from the user.

### Exemplary Detection of the of the Excitation Signal Within the Communication Device

Referring back to FIG. 3, the touch-screen controller 308 can determine the one or more signal metrics of the interface signal 152 that has capacitively transferred to the touch-screen 104. The touch-screen controller 304 can compare the one or more signal metrics to determine a location of the touch from the touch-based stylus 106. Alternatively, the communication device 102 can compare the one or more signal metrics to one or more signal metric thresholds to determine a location of the touch from the touch-based stylus 106. Optionally, the touch-screen controller 308 can use the one or more signal metrics to determine an action of the user. For example, in some instances, the touch-based stylus 106 can include one or more physical buttons. In this example, when at least one of the one or more physical buttons is activated, a frequency and/or a phase of the interface signal 152 that is transferred onto the touch-sensitive area changes. This change in frequency and/or phase can be detected and interpreted by the touch-screen controller 308 to indicate activation of the one or more buttons by the user. In some instances, the touch-screen controller 308 and the host processor 304 can be implemented using a single processor that performs the various functions of the touch-screen controller 308 and the host processor 304. Further, the touch-screen controller 308 can interpret the location of the touch from the touch-based stylus 106 as being one or more commands and/or data from the user.

The communication interface 310 routes various communications between the communications module 302, the host processor 304, and the touch-screen controller 308. The communication interface 310 can be implemented as a series of wired and/or wireless interconnections between the communications module 302, the host processor 304, and the touch-screen controller 308. The interconnections of the communication interface 310 can be arranged to form a parallel interface to route communications between the communications module 302, the host processor 304, and the touch-screen controller 308 in parallel, or a serial interface to route communications between the communications module 302, the host processor 304, and the touch-screen controller 308, or any combination thereof.

### Exemplary Touch-Based Stylus That Can Be Implemented Within the Operating Environment

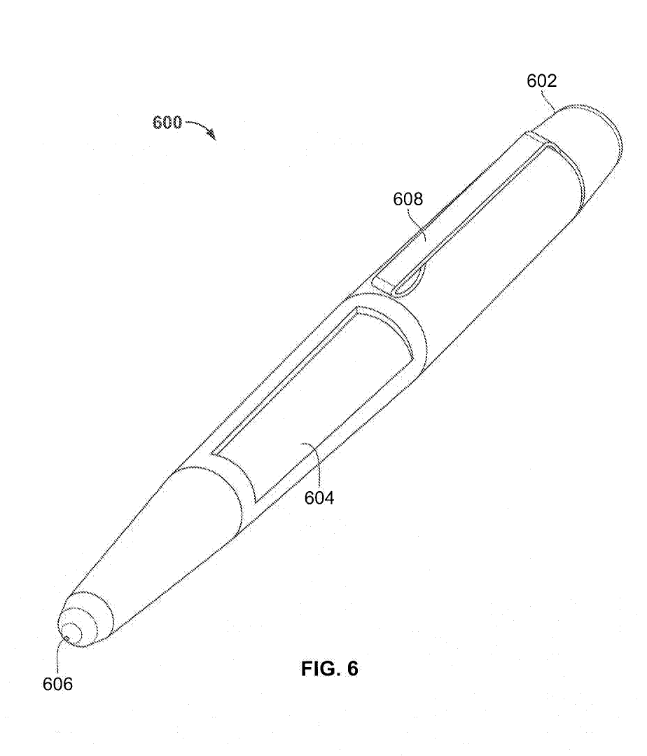

FIG. 6 illustrates a simplified block diagram of an exemplary touch-based stylus that can be implemented within the exemplary operating environment. A touch-based stylus 600 capacitively and/or inductively receives an excitation signal, such as the excitation signal 250 and/or the excitation signal 450 to provide some examples, from a communication device, such as the communication device 102, the communication device 300, and/or the communication device 400 to provide some examples. The excitation signal causes the touch-based stylus 600 to resonate at its respective resonant frequency. The resonating of the touch-based stylus 600 causes a voltage to accumulate when touched by the user. This charge capacitively and/or inductively transfers to a touch-sensitive area of a touch-screen of the communication device when the touch-based stylus 600 touches, or is sufficiently proximate, to the touch-sensitive area. The touch-based stylus 600 includes a mechanical chassis 602, a touch-based stylus core 604, and a conductive tip 606. The touch-based stylus 600 can represent an exemplary embodiment of the touch-based stylus 106.

The mechanical chassis 602 represents a mechanical enclosure for the touch-based stylus 600. It is often constructed using a conductive material, such as metal, a non-conductive material, such as plastic, or any combination of the conductive and the non-conductive materials that will be apparent to those skilled in the relevant art(s) without departing from the spirit and scope of the present disclosure. Typically, the mechanical chassis 602 includes one or more conductive regions that are coupled to the touch-based stylus core 604. The one or more conductive regions can form a virtual ground for the touch-based stylus core 604 when grasped by a user. In an exemplary embodiment, the one or more conductive regions include a conductive holder or clasp 608 that fauns the virtual ground when grasped by the user. In another exemplary embodiment, the mechanical chassis 602 includes one or more non-conductive regions that are interdigitated with the one or more conductive regions such that the one or more conductive regions can form the virtual ground for the touch-based stylus core 604 when grasped by the user. The one or more non-conductive regions can be horizontally and/or vertically interdigitated with the one or more conductive regions. In some instances, the mechanical chassis 602 can include one or more buttons. In these instances, when the user activates the one or more buttons, a frequency and/or a phase of the charge that is transferred onto the touch-sensitive area of the communication device changes. This change in frequency and/or phase can be detected and interpreted by the communication device to indicate activation of the one or more buttons by the user.

The touch-based stylus core 604 can be implemented using one or more passive devices, such as one or more resistances, one or more capacitances, and/or one or more inductances to provide some examples. The one or more passive devices are configured and arranged to form a resonant tuned circuit, such as a LC tuned circuit or RLC tuned circuit to provide some examples. Typically, the one or more passive devices include one or more charge storage elements, such as one or more capacitances to provide an example. In an exemplary embodiment, the one or more charge storage elements charge upon a rising edge of the excitation signal and discharge upon a falling edge of the excitation signal. Once these storage elements begin to discharge, the touch-based stylus core 604 begins to resonate or oscillate at a resonant frequency to cause a voltage to accumulate in the conductive tip 606 when a conductive portion of the mechanical chassis 602 is touched by the user.

In an exemplary embodiment, the touch-based stylus core 604 can include one or more stylus controllers and one or more associated machine-readable media for storing one or more operational parameters of the touch-based stylus 600. In this exemplary embodiment, the one or more operational parameters can include one or more profile settings that can be customizable by the user for displaying information onto a communication device, such as the communication device 102, the communication device 200, the communication device 300 or the communication device 500 to provide some examples. In an exemplary embodiment, the user can customize the one or more profile settings of the communication device which can be provided by the communication device to the touch-based stylus 600. In this exemplary embodiment, the one or more profile settings can be provided by the touch-based stylus 600 to another communication device to configure the other communication device in a substantially similar manner as the communication device. The one or more profile settings can include an image, as referred to as wallpaper, to be displayed in a display of the communication device, color and appearance of the display of the communication device, sounds effects to be played by the communication device, screen saver to be used by the communication device, screen resolution of the display of the communication device, authentication or authorization information, such as user name and/or password to provide some examples, to be used by the communication device.

The conductive tip 606 represents a region of the touch-based stylus 600 which accumulates the charge when the touch-based stylus 600 is resonating. In an exemplary embodiment, the conductive tip 606 is isolated from the mechanical chassis 602, typically the one or more conductive regions, using a non-conductive material. The voltage that accumulates in the conductive tip 606 capacitively and/or inductively transfers from the touch-based stylus 600 to a touch-sensitive area of a touch-screen of the communication device when the conductive tip 606 touches, or is sufficiently proximate, to the touch-sensitive area. In some instances, the conductive tip 606 can represent a pressure sensitive element having a pressure varying capacitor which can change the resonant frequency of the resonant tuned circuit when the touch-based stylus 600 is pressed onto the touch-sensitive area of the touch-sensitive area of the communication device. In these instances, the communication device can measure a difference in frequency, namely a difference between an expected frequency and an actual frequency, to determine whether the pressure sensitive element is pressed onto the touch-sensitive area.

### Exemplary Touch-Based Stylus Core That Can Be Implemented Within the Touch-Based Stylus

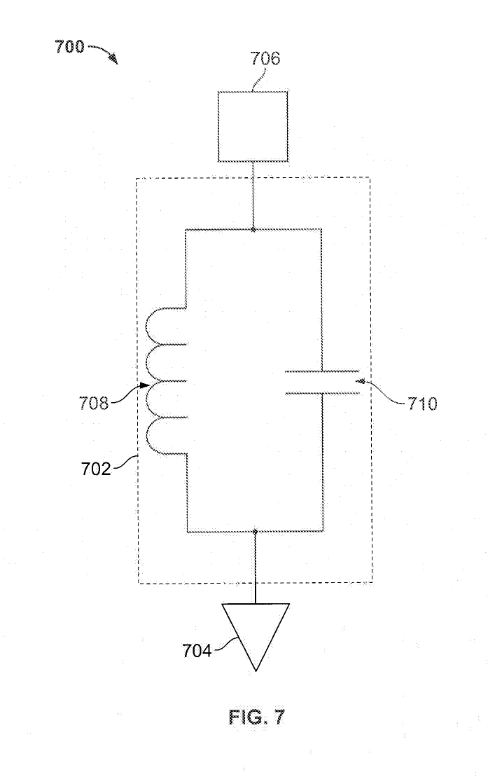

FIG. 7 illustrates a more extensive block diagram of the exemplary touch-based stylus. A touch-based stylus 700 capacitively and/or inductively receives an excitation signal, such as the excitation signal 250 and/or the excitation signal 450 to provide some examples, from a communication device, such as the communication device 102, the communication device 300, and/or the communication device 400 to provide some examples. The excitation signal causes the touch-based stylus 700 to resonate at its respective resonant frequency. The resonating of the touch-based stylus 700 causes a voltage to accumulate when touched by the user. This charge capacitively and/or inductively transfers to a touch-sensitive area of a touch-screen of the communication device when the touch-based stylus 700 touches, or is sufficiently proximate, to the touch-sensitive area. The touch-based stylus 700 includes a resonant tuned circuit 702, a conductive tip 704, and one or more conductive regions 706. The touch-based stylus 700 can represent an exemplary embodiment of the touch-based stylus 106 and/or the touch-based stylus 600.

The resonant tuned circuit 702 capacitively and/or inductively receives the excitation signal from the communication device. The excitation signal causes the touch-based stylus 106 to resonate at its respective resonant frequency. The touch-based stylus core 702 can be implemented using one or more passive devices, such as one or more resistances, one or more capacitances, and/or one or more inductances to provide some examples, which are configured and arranged to form a resonant tuned circuit, such as a LC tuned circuit or RLC tuned circuit to provide some examples. As illustrated in FIG. 7, the resonant tuned circuit 702 includes an inductance 708 and a capacitance 710 that are configured and arranged to form a parallel LC tuned circuit. However, this example is not limiting. Those skilled in the relevant art(s) will recognize that other parallel tuned circuits, as well as series tuned circuits, using other combinations of one or more passive devices, such as one or more resistances, one or more capacitances, and/or one or more inductances are possible without departing from the spirit and scope of the present disclosure. Typically, the inductance 708 inductively receives the excitation signal from the communication device via mutual inductance between the resonant tuned circuit 702 and the communication device.

In an exemplary embodiment, the inductance 708 can be implemented using unshielded cable formed of a conductive material, such as copper to provide an example, that is configured and arranged to form one or more turns. These one or more turns can be enclosed within one or more non-conductive regions of a mechanical chassis, such as the mechanical chassis 602 to provide an example, of the touch-based stylus 700. The one or more non-conductive regions can allow the excitation signal to pass through the mechanical chassis to be inductively received by the inductance 708. The one or more turns can be configured and arranged to form any regular geometric structure, irregular geometric structure, open structure, close structure, or any combination thereof within the mechanical chassis such as around the perimeter of the mechanical chassis. Other configurations and arrangements for the inductance 708 are possible without departing from the spirit and scope of the present disclosure. For example, the inductance 708 can be implemented as a one or more turns of conductive material integrated within the non-conductive regions of the mechanical chassis. As another example, the inductance 708 can be implemented within a perimeter of the resonant tuned circuit 702 using a waveguide, such as stripline or microstrip to provide some examples, whereby the excitation signal can pass through the non-conductive regions of the mechanical chassis to be inductively received by the inductance 708.

The resonating of the resonant tuned circuit 702 causes a voltage to accumulate within the conductive tip 704 when touched by the user. This charge capacitively transfers to a touch-sensitive area of a touch-screen of the communication device when the conductive tip 704 touches, or is sufficiently proximate, to the touch-sensitive area. Generally, a shape of the conductive tip 704 is chosen such that the projection of the conductive tip 704 onto the communication device is relatively independent of the angle of the conductive tip 704 when touching the communication device with the touch-based stylus 700. In an exemplary embodiment, the conductive tip 704 can be implemented using a substantially spherical shape which is electrically connected to resonant tuned circuit 702. In this exemplary embodiment, additional non-conductive materials can be used within the conductive tip 704 to provide mechanical support to the substantially spherical shape. In another exemplary embodiment, any material covering the conductive tip 704 should be chosen to provide an appropriate texture to substantially match the feel of writing with a pen on paper. In a further exemplary embodiment, the conductive tip 704 can be implemented using a cylinder having one end being in an approximate shape of a half sphere. Preferably, a length of the cylinder should not be much more than a diameter of the half-sphere.

The one or more conductive regions 706 can form a virtual ground for the touch-based stylus core 700 when grasped by the user. The virtual ground maintains the touch-based stylus core 700 at a substantially steady reference potential to allow the resonant tuned circuit 702 to resonate upon receipt of the excitation signal.

### Exemplary Operation of the Touch-Based Stylus

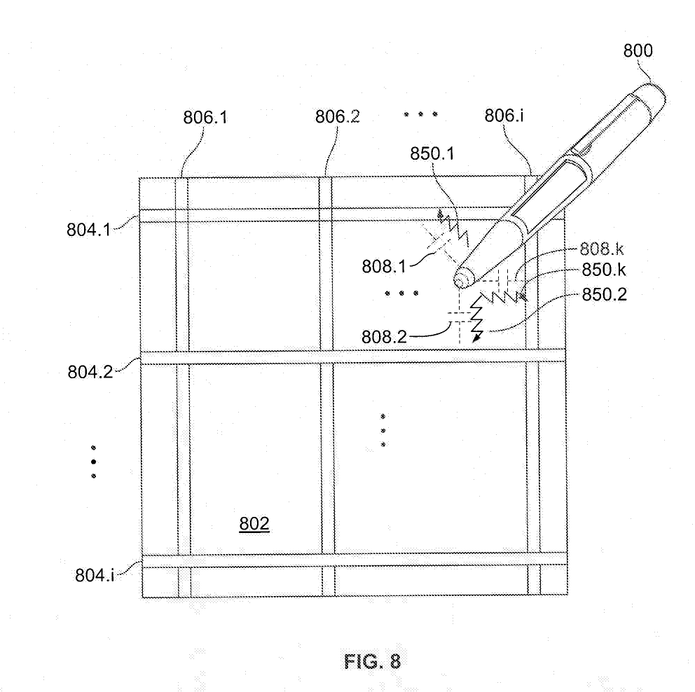

FIG. 8 illustrates a block diagram of an exemplary operation of the touch-based stylus. A touch-based stylus 800 capacitively and/or inductively receives an excitation signal, such as the excitation signal 250 and/or the excitation signal 450 to provide some examples, from a communication device, such as the communication device 102, the communication device 300, and/or the communication device 400 to provide some examples. The excitation signal causes the touch-based stylus 800 to resonate at its respective resonant frequency. The resonating of the touch-based stylus 800 causes a voltage to accumulate when touched by the user. This charge capacitively transfers to a touch-sensitive area of a touch-screen of the communication device when the touch-based stylus 800 touches, or is sufficiently proximate, to the touch-sensitive area.

As illustrated in FIG. 8, a touch-screen 802 includes rows 804.1 through 804.1 of transparent conductive material, such as indium tin oxide to provide an example, and columns 806.1 through 806.i of the transparent conductive material that are arranged to form a touch-sensitive area of the touch-screen 802. The rows 804.1 through 804.i, and the columns 806.1 through 806.i may be configured to form a touch-sensitive area of a touch-screen such as the touch-screen 104, touch-screen 104, and/or the touch-screen 406 to provide some examples. Typically, a conductive tip, such as the conductive tip 606 and/or the conductive tip 704 to provide some examples, within the touch-based stylus 800 forms a first electrode of one or more capacitors 808.1 through 808.k. The rows 804.1 through 804.i and/or and columns 806.1 through 806.i of the transparent conductive material form a corresponding second electrode of the one or more capacitors 808.1 through 808.k when the touch-based stylus 800 touches, or is sufficiently proximate, to the touch-sensitive area of the touch-screen 802.

The voltage that accumulates in the conductive tip, when the touch-based stylus 800 is touched by the user, capacitively transfers from the conductive tip to the rows 804.1 through 804.i and/or and columns 806.1 through 806.i of the transparent conductive material through the one or more capacitors 808.1 through 808.k to provide interface signals 850.1 through 850.k. Typically, an intensity of each of the interface signals 850.1 through 850.k is proportional to a distance from the conductive tip to its corresponding rows 804.1 through 804.i and/or and columns 806.1 through 806.i. A larger distance usually results in a smaller capacitance whereas a smaller distance usually results in a larger capacitance. Those interface signals 850.1 through 850.k that are capacitively transferred from larger capacitances typically exhibit a larger intensity than those interface signals 850.1 through 850.k that are capacitively transferred from smaller capacitances.

### Conclusion

The following Detailed Description referred to accompanying figures to illustrate exemplary embodiments consistent with the disclosure. References in the disclosure to “an exemplary embodiment” indicates that the exemplary embodiment described can include a particular feature, structure, or characteristic, but every exemplary embodiment may not necessarily include the particular feature, structure, or characteristic. Moreover, such phrases are not necessarily referring to the same exemplary embodiment. Further, any feature, structure, or characteristic described in connection with an exemplary embodiment can be included, independently or in any combination, with features, structures, or characteristics of other exemplary embodiments whether or not explicitly described.

The Detailed Description is not meant to limiting. Rather, the scope of the disclosure is defined only in accordance with the following claims and their equivalents. It is to be appreciated that the Detailed Description section, and not the Abstract section, is intended to be used to interpret the claims. The Abstract section can set forth one or more, but not all exemplary embodiments, of the disclosure, and thus, are not intended to limit the disclosure and the following claims and their equivalents in any way.

The exemplary embodiments described within the disclosure have been provided for illustrative purposes, and are not intend to be limiting. Other exemplary embodiments are possible, and modifications can be made to the exemplary embodiments while remaining within the spirit and scope of the disclosure. The disclosure has been described with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

Embodiments of the disclosure can be implemented in hardware, firmware, software, or any combination thereof. Embodiments of the disclosure can also be implemented as instructions stored on a machine-readable medium, which can be read and executed by one or more processors. A machine-readable medium can include any mechanism for storing or transmitting information in a form readable by a machine (e.g., a computing device). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software, routines, instructions can be described herein as performing certain actions. However, it should be appreciated that such descriptions are merely for convenience and that such actions in fact result from computing devices, processors, controllers, or other devices executing the firmware, software, routines, instructions, etc.

The Detailed Description of the exemplary embodiments fully revealed the general nature of the disclosure that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

What is claimed is:

1. A communication device, comprising:
a communication module configured to provide an excitation signal to cause a touch-based stylus to resonate;
a touch-screen, having a touch-sensitive area, configured to receive a first interface signal at a first region within the touch-sensitive area and a second interface signal at a second region within the touch-sensitive area when the touch-based stylus is resonating; and
a touch-screen controller configured to compare a first signal metric of the first received interface signal and a second signal metric of the second received interface signal to determine a location of the touch-based stylus.

2. The communication device of claim 1, wherein the communication module is configured to inductively provide the excitation signal.

3. The communication device of claim 1, wherein the communication module comprises:
a near field communication (NFC) module configured to provide wireless communication between the communication module and another NEC capable device, the NFC module comprising:
an antenna,
wherein the touch-screen controller is further configured to cause the NFC module to provide the excitation signal using the antenna.

4. The communication device of claim 1, wherein the touch-screen comprises:
a plurality of rows of conductive material; and
a plurality of columns of the conductive material, the plurality of rows and the plurality of columns being configured and arranged to form the touch-sensitive area, and
wherein the first region represents a first row from among the plurality of rows or a first column from among the plurality of columns, and the second region represents a second row from among the plurality of rows or a second column from among the plurality of columns.

5. The communication device of claim 4, wherein the touch-screen is configured to capacitively receive the first interface signal and the second interface signal.

6. The communication device of claim 7, wherein a first distance from the first region to the touch-based stylus is smaller than a second distance from the second region to the touch-based stylus such that the first received interface signal has a larger intensity when compared to the second received interface signal.

7. The communication device of claim 1, wherein the communication device is configured to communicate an operational parameter to the touch-based stylus.

8. A touch-based stylus, comprising:
a touch-based stylus core configured to resonate at a resonant frequency in response to receiving an excitation signal from a communication device; and
a conductive tip configured to accumulate charge when the touch-based stylus core is resonating and to transfer the charge to the communication device when the conductive tip is sufficiently proximate to the communication device.

9. The touch-based stylus of claim 8, further comprising:
a mechanical chassis, the mechanical chassis comprising:
a conductive region configured to form a virtual ground for the touch-based stylus core when grasped by a user.

10. The touch-based stylus of claim 9, wherein the mechanical chassis further comprises:
a non-conductive region configured to allow the excitation signal to pass through the mechanical chassis onto the touch-based stylus core.

11. The touch-based stylus of claim 9, wherein the mechanical chassis is further configured to enclose an inductance of the touch-based stylus core.

12. The touch-based stylus of claim 8, wherein the mechanical chassis comprises:
a button or a switch configured to change a frequency or a phase of the charge when activated.

13. The touch-based stylus of claim 8, wherein the touch-based stylus core comprises:
a resonant tuned circuit configured to resonate at the resonant frequency in response to receiving the excitation signal.

14. The touch-based stylus of claim 8, wherein the touch-based stylus core comprises:
a stylus controller, and
a machine-readable media configured to store an operational parameter to configure a display area of a communication device.

15. The touch-based stylus of claim 8, wherein the conductive tip comprises:
a pressure sensitive element configured to change the resonant frequency of the touch-based stylus core when pressed onto a touch-sensitive area of a touch-screen of the communication device.

16. The touch-based stylus of claim 8, wherein the touch-based stylus core is further configured to inductively receive the excitation signal from the communication device, and
wherein the conductive tip is configured to capacitively transfer the charge to the communication device.

17. A method for interfacing a communication device using a touch-based stylus, comprising:
resonating, by the touch-based stylus, in response to inductively receiving an excitation signal;
accumulating, by the touch-based stylus, charge when resonating;
capacitively receiving, by the communication device, the charge at a first region to provide a first interface signal and a second region to provide a second interface signal;
determining, by the communication device, a first signal metric of the first interface signal and a second signal metric of the second interface signal; and
comparing, by the communication device, the first signal metric to the second signal metric to determine a location of a touch of the touch-based stylus.

18. The method of claim 17, further comprising:
magnetically inducing, by the communication device, a voltage or a current in the touch-based stylus to cause the touch-based stylus to resonate.

19. The method of claim 17, further comprising:
forming, by the touch-based stylus, a virtual ground for a resonant tuned circuit when the touch-based stylus is grasped by a user.

20. The method of claim 17, further comprising:
providing, by the communication device, the excitation signal when the touch-based stylus is removed from a pressure sensitive cavity within a mechanical housing of the communication device; and
ceasing, by the communication device, to provide the excitation signal when the touch-based stylus is placed within the pressure sensitive cavity.
